(19) United States
(12) Patent Application Publication
(10) Pub. No.: US 2005/0209870 A1
(43) Pub. Date: Sep. 22, 2005

(54) Consumer products marketing process and method

(76) Inventor: Ray M. Alden, Raleigh, NC (US)

Correspondence Address: Ray M. Alden, 808 Lake Brandon Trail, Raleigh, NC, 27610, US

(21) Appl. No.: 10/806,364

(22) Filed: Mar. 22, 2004

(51) Int. Cl. G06F 17/60

(52) U.S. Cl. 705/1

(57) ABSTRACT

This invention provides a means for establishing communications with the consumers of a product comprising a step of placing a respective unique product identifier on each respective unit of a product produced by a company. Communications are facilitated by additional steps of inviting the consumer to visit a website and enter the unique product identifier code into the website for one or more chances to win a prize. In exchange for this chance, the consumer must enter data about themselves which are stored in the company's database and used for subsequent marketing communications. The process described herein will enable the company to generate word of mouth promotion, additional sales, and return on investment.

### BACKGROUND FIELD OF INVENTION

The technique known as permission marketing has in recent years been recognized as a valuable means to connect and establish a relationship with a company's customers. Some well known methods of permission marketing are facilitated by low cost internet based communications and entail driving customers to a company's website, gathering information about the customers, and tacitly gaining their permission to engage in ongoing communications. Ongoing communications enable enhancing brand identity and very low cost high frequency communications that have been show to increase product sales and ultimately return on investment. Several challenges present themselves when contemplating a permission marketing campaign including how to establish initial communications with customers to motivate them to go to the company's website, how to create a value proposition appealing to customers on the website that motivates them to give the company information that can facilitate communications with them, and leaves them interested in receiving communications from the company, how to create website “stickiness” that keeps the customers coming back to the site, and how to increase sales and return on investment as a result of engaging in the campaign.

The present invention is a process for establishing communications with customers and motivating them to go to the company's website, creating a value proposition appealing to customers visiting the website that motivates them to give desired information to facilitate communications with them and leaves them interested in receiving communications from the company, creating website “stickiness” that keeps the customers coming back to the site, and increasing sales and return on investment as a result the process.

### BACKGROUND—DESCRIPTION OF PRIOR INVENTION

Many consumer product companies are succeeding in gaining consumer traffic to their website and from their engaging them in a dialog with the goal of enhancing brand, consumer loyalty, and ultimately increasing product purchases. Kraft is a consumable products company that is very highly rated in the field of engaging consumers through their website. Kraft has demonstrated that their food product sales have actually increased as a result of the traffic on their website. One of the main problems associated with engaging the consumer through a website, is the challenge of first getting the consumer to visit a company's website. Consumer product packing often includes the company's website address and an invitation to go to the site. For Kraft, the invitation may involve free recipes for example. No known consumer products company is using prizes associated with each consumption of its product as the means to drive the consumer to their sites as described herein.

Unique product identification numbers have heretofore been provided in products such as software. Often when one installs software applications for example, one must key in an alphanumeric identifier located on the software's packaging. In this scenario, the unique identifier is provided to prevent copy right infringement. Software is not a consumable product. No example of a consumable product having a unique identifier enclosed within its packaging is known. Moreover no example is known where such consumable product unique identifiers are used to repeatedly engage the consumer in repeat product purchases and communications with a company as described herein.

### BRIEF SUMMARY

The present invention is a process for establishing communications with customers and motivating them to go to the company's website, creating a value proposition appealing to customers visiting the website that motivates them to give desired information to facilitate communications with them and leaves them interested in receiving communications from the company, creating website “stickiness” that keeps the customers coming back to the site, and increasing sales and return on investment as a result the process.

In one embodiment, the present invention involves a process having steps including placing a respective unique unit identification code (UUIC) on each respective unit of a product that a company produces. After a unit of the product is purchased and consumed, the consumer can access the UUIC code from the product packaging including instructions to navigate to the company's website, enter the UUIC and potentially win a prize. The consumer then navigates to the company's website and is asked to create a user ID including email address and other information of interest to the company. This information is stored in the company's database for subsequent data mining and company initiated communications. A user ID is then sent to the consumer by email to ensure that the consumer's email address is correct. The consumer receives the company's confirming email together with an access code enabling them to sign into the company's website and enter the UUIC for a chance to win the prize. The company's database includes data about all of the UUIC's and a game program that uses the UUIC together with the user's profile to calculate whether the consumer is an immediate winner and to establish whether the customer is potentially a contender for winning a future grand prize.

Other additional steps can include enabling the user to enter another UUIC and replay the game each time he subsequently consumes another unit of the product. Another step may be that each time the consumer enters another UUIC, their chances of wining increase. Another step may include the ability of the consumer to enter the email addresses of friends who are or will be playing the game for an increased chance of winning. Another step may include that the status of the consumer's ability to win future prices may change over time as determined by the company's game software and developments regarding other consumers who are participating. Thus the consumer will want to check the website periodically to determine what their status is; are they eligible to win the future prize or are they not. Either way, entering additional UUIC codes will enhance their chances of winning future prizes.

Objects and Advantages

Accordingly, several objects and advantages of the invention are apparent. It is an object of the present invention to provide a process for collecting information about the consumers of a company's products. This gives the company the advantage of more precisely targeting of their marketing efforts to similar consumers. It is an object of the present invention to gain marketing insights into consumer behavior by using a UUIC to connect a specific consumer with the consumption of a specific unit of a particular product. This gives the company the advantage of a deeper understanding of consumer product acquisition behavior. It is an object of the present invention to motivate the consumer to give their information including email address to the company and to give their tacit invitation (permission) to the company to communicate to them on an ongoing basis. This offers the company the advantage of being able to communicate with the consumer in a welcomed manner. It is an object of the present invention to use consumer word of mouth to generate interest in the company's products. Asking the consumer to link to their friends in the game and bring them into the game offers the company the advantage of creating a word of mouth communication around their products and website. It is an object of the present invention to increase sales revenue. It is an advantage to the company that each time the consumer enters a new UUIC into the game, their chance of winning increases. It is an object of the present invention to create a “stickiness” to a company's website. Creating contender and non-contender statuses effecting eligibility to win a future prize that may change after the consumer leaves the game makes the consumer want to check back into the website periodically to see what their status is, are they still a contender to win our have they been downgraded to non-contender status ineligible to win without entering a new UUIC. Other objects and advantages will become apparent by reviewing the specifications and drawing figure.

### DRAWING FIGURES

FIG. 1 illustrates a permission marketing process of the present invention.

FIG. 2a illustrates a first side of a first uniquely identified candy wrapper.

FIG. 2b illustrates a first side of a second uniquely identified candy wrapper.

FIG. 2c illustrates the second side of the second wrapper of FIG. 2b around a consumable candy bar with the unique identifier on the inside of the wrapper.

FIG. 2d illustrates the inside of a first uniquely identified bottle cap.

FIG. 2e illustrates the inside of a second uniquely identified bottle cap.

FIG. 2f illustrates the outside of the second bottle cap of FIG. 2e on the top of a bottle with the unique identifier not visible from the outside of the product.

### DETAILED DESCRIPTION OF THE INVENTION

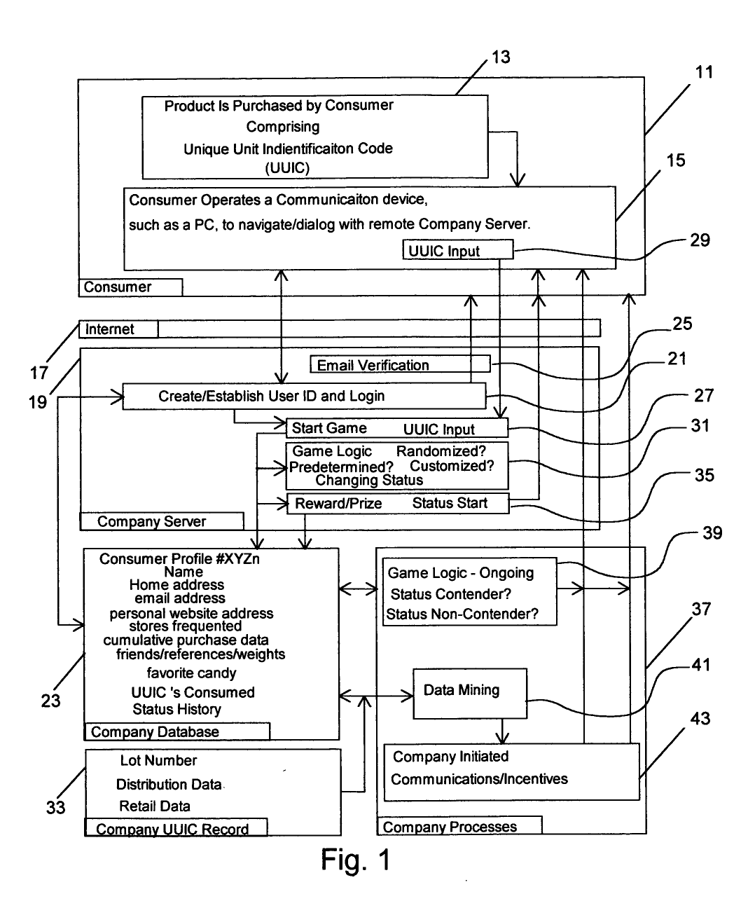

FIG. 1 illustrates a permission marketing process of the present invention. A consumer 11 purchases a consumer product 13 such as a candy bar for example which includes inside of its wrapper a unique unit identification code (UUIC). The UUIC is an alphanumeric number (or other identifier such as a scan able bar codes) that has been preprinted on the inside of the candy wrapper and prerecorded in the candy bar manufacturer's database. Also included on the candy bar's wrapper are instructions directing the consumer to the company's website for potentially winning prizes. The consumer uses a communication device such as a PC 15 to navigate through an internet 17 to the company's website which is served by a server 19. The server requests that the user sign in or establish a user ID 21. Since the consumer is new to the site, he responds to establish an ID and to ensuing questions sent by the server. The consumer's response are captured by the company in a database 23. After the consumer has finished responding to questions sent by the server, the server sends an email 25 verifying for the consumer a unique consumer's user ID 25. Using the unique ID, the consumer logs in and the server presents a start of game notice 21 which enables the user to input the UUIC. The object of the game is to win prizes. To begin playing the game, the consumer completes a UUIC input 29 providing the alphanumeric code to the server. Using a predefined game logic 31, the server determines if the consumer has won a prize and a prize communication 35 reports the results to the consumer either directly through the current server session or indirectly through an email. The server also similarly reports the communication 35 of whether the consumer has a contender status and is eligible to win a future grand prize or has a non-contender status who is not eligible to win the future grand prize. The logic of immediate game results and of future status can include randomized elements, predetermined results elements, and elements that are customized according to the data pertaining to the consumer and possibly compared to other participants in the game. The game logic may also incorporate data contained in a UUIC record 33 which gets populated from the record 33 into the company database 23 after the UUIC is keyed in by the consumer. The game logic 31 may simply be a random selection of a predetermined number of instant winners who get a predetermined range of prizes. Additionally, if consumers are giving status as a contender for the future grand prize, an ongoing game logic 39 will determine how their status changes going forward. It may report that their status has changed to non-contender status at a future point in time. The odds of winning the grand prize may increase as a function of UUICs and friends the consumer has entered into the game. Friends can be entered into the database 23 and the server will send email to the friend to confirm the address is correct, the friend then having to setup a user ID and enter in at least one UUIC to themselves become active game participants. The consumer's status of being a contender for the grand may change according to game logic as time progresses so the user has to frequently check back in with the game to determine whether the are a contender or non-contender for the grand prize.

Periodically, the company may use a data mining program 41 that uses data collected from the consumer and many thousands of other consumers to create a targeted communication 43 or other marketing campaign. The ongoing game logic, data mining, and communications are a set of company processes 37 that occur subsequent to the consumer's initial UUIC entry and game participation

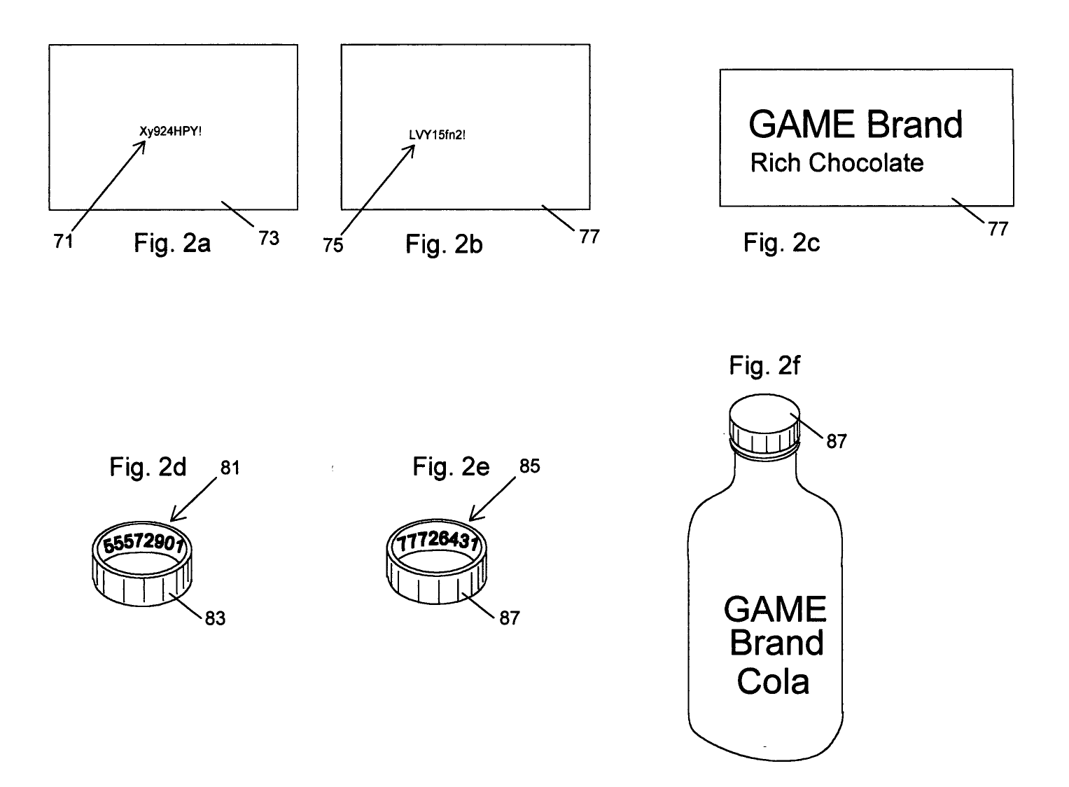

FIG. 2a illustrates a first side a first uniquely identified candy wrapper. A first UUIC identifier 71 is printed on the inside of a first candy bar wrapper 73. The first UUIC distinguishes the consumer product from other identical consumer products.

FIG. 2b illustrates a first side of a second uniquely identified candy wrapper. A second UUIC identifier 75 is printed on the inside of the second candy bar wrapper 77. The second UUIC distinguishes the consumer product from other identical consumer products.

FIG. 2c illustrates the second side of the second wrapper of FIG. 2b around a consumable candy bar with the unique identifier on the inside of the wrapper. Whereas the inside of 77 was visible in FIG. 2b, the outside of 77 is visible in FIG. 2c. The UUIC is not visible from the outside but only becomes visible when the product is opened to be consumed.

FIG. 2d illustrates the inside of a first uniquely identified bottle cap. A first bottle cap 83 has a third UUIC 81 on the inside which distinguishes it from other bottle caps of the same product.

FIG. 2e illustrates the inside of a second uniquely identified bottle cap. A second bottle cap 87 includes a fourth UUIC 85 which distinguishes it from other bottle capos of the same product.

FIG. 2f illustrates the outside of the second bottle cap of FIG. 2e on the top of a bottle with the unique identifier not visible from the outside of the product. The fourth UUIC 85 of FIG. 2e can not be seen until the second bottle cap 87 has been removed from the bottle.

Operation of the Invention

Operation of the invention has been discussed under the above heading and is not repeated here to avoid redundancy.

Conclusion, Ramifications, and Scope

Thus the reader will see that the Consumer Products Marketing Process and Method of this invention provides a novel unanticipated, highly functional and reliable means for engaging and tracking a company's consumers in a manner welcomed be consumers.

While the above description describes many specifications, these should not be construed as limitations on the scope of the invention, but rather as an exemplification of a preferred embodiment thereof. Many other variations are possible.

A unique bar code could also be used as the UUIC for the product. The consumer could operate a device other than a PC such as a cell phone, laptop, PDA, or camera to access the company website.

Marketing of many types of products including food, beverages, cigarettes, and others can be facilitated using the process described herein.

1. A process for an organization to communicate with consumers of a product comprising the steps of;
placing a unique unit identifier on said product or its packaging,
positioning the unit identifier so that it can not be known prior to the opening or consumption of said product,
and providing a facility for the communication of said unit identifier by said consumer to said organization,
wherein the opening or consumption of said product accelerates its perish-ability.
